(19) United States
(12) Patent Application Publication
(10) Pub. No.: US 2016/0335687 A1
(43) Pub. Date: Nov. 17, 2016

(54) SYSTEM AND METHOD FOR ENHANCING AN ONLINE SHOPPING EXPERIENCE BY CAPTURING THE PRODUCT IDENTIFIER

(71) Applicant: Maximilien Lejeune, Bages (FR)

(72) Inventor: Maximilien Lejeune, Bages (FR)

(21) Appl. No.: 14/711,121

(22) Filed: May 13, 2015

(51) Int. Cl. G06Q 30/06; G06K 19/06; G06Q 30/02

(52) U.S. Cl. CPC G06Q 30/0617; G06Q 30/0241; G06K 19/06037

(57) ABSTRACT

The present invention relates to a system and method for enhancing an online shopping experience by capturing and advertising a Quick Response (QR) code of the product. Products of the registered retailers are maintained in a repository along with the generated QR code and the generated QR code can be advertised on various marketing media. Further, the consumers can scan the advertised QR code or search for the product in the inventory database using a client application and purchase the product online through the online shopping platform. Further, the method handles the payment related aspect of the initiated transaction through the online payment system by adopting a security measure.

### FIELD OF THE INVENTION

The present invention generally relates to enhancing an online shopping experience and more particularly relates to enhancing an online shopping experience by facilitating an online shopping platform to capture the Quick Response (QR) code of a product that can be advertised across various marketing media to allow the consumers to purchase the product online and by providing a secure payment transaction for consumers.

### BACKGROUND OF THE INVENTION

As most of the consumers have internet connectivity, online shopping becomes the most preferred way of shopping. Further, usage of Quick Response (QR) code for identifying the product or package makes it more convenient for the consumers to select the product online for purchasing.

At times, consumers may want to purchase products through hand-held device by scanning the products advertised on various marketing sites. The existing online shopping system does not allow the consumer to use the hand-held device to scan the product and initiate a transaction for purchasing the scanned product. Using hand-held device for purchasing products avoids the consumer to stand in long-queues to select the product or to make payments for the initiated transaction. Further, the hand-held device must be capable of making payments for the initiated transaction through various modes, such as through credit-card, cashless, cash, online payment system, or the like.

Hence, there is a need for an online shopping platform that can enhance the consumer's shopping experience by identifying the product to be purchased through a hand-held device and completing the transaction in a secure manner through the hand-held device.

### SUMMARY OF THE INVENTION

The present invention relates to a system and method for enhancing an online shopping experience by capturing Quick Response (QR) code for the products through an online shopping platform web interface, wherein the method comprises of registering one or more retailer's information through an online shopping platform web interface. Further, the method generates Quick-Response (QR) codes for one or more products and dispatches the generated QR codes of the products for marketing purpose on the marketing media. An inventory of the products along with the QR codes is maintained in an inventory database for the registered retailer. Further, the method allows the registered retailer to create a payment account through any of the existing online payment system and allocates the QR codes for the products. Further, the method allows the registered retailer to print or copy the QR code and advertise the QR code on one or more marketing media, which can be scanned by the consumers to purchase the product from the inventory. Optionally, the method allows the consumer to search for the product maintained in the product repository through a client application or a mobile interface. Further, the method receives one or more transactions initiated by the consumer to buy the products, and based on the initiated transaction, the method checks for the availability of the product and handle the payment aspect of the initiated transaction through the online shopping platform to complete the initiated transaction. Further, the method ensures a secure payment transaction for the consumer involved in a purchasing activity by releasing the payment amount to the registered retailer's account after a stipulated period of time from the delivery date of the purchased product.

### BRIEF DESCRIPTION OF DRAWINGS

FIG. 1 illustrates a working overview of the system 100 used to implement the method for enhancing an online shopping experience by capturing the Quick Response (QR) codes for one or more products through an online shopping platform 102.

FIG. 2 illustrates a flow-chart 200 that explains the process of generating the QR code and maintaining the product list in the registered retailer's inventory.

FIG. 3 illustrates a flow-chart 300 that explains the process of initiating a transaction through a consumer's device.

FIG. 4 illustrates an overview of handling payment aspect associated with an initiated transaction.

FIG. 5 illustrates a system overview 500 of components used to implement the method for enhancing an online shopping experience by capturing the Quick Response (QR) code through an online shopping platform 102.

FIG. 6 illustrates a screen-shot of the online shopping platform 102 main page.

FIGS. 7a and 7b illustrate screen-shots of the online shopping platform 102 used to capture information related to a retailer and associated products.

FIG. 8 illustrates screen-shot of the online shopping platform 102 web interface for creating a payment account.

FIG. 9 illustrates screen-shot of products available in the online shopping platform 102 repository.

FIGS. 10a and 10b illustrate screen-shots of product ordering status maintained by the online shopping platform 102.

FIG. 11 illustrates a client application scanning the QR code of the product on the consumer device 104.

### FIGURE DESCRIPTION

100—A working overview of the system
101—A network within which the system works
102—An online shopping platform
103—A registered retailer
104—A consumer initiating a transaction to purchase one or more products
105—A Quick Response (QR) code generated for a product associated with the registered retailer
106—An online payment system
107—A QR code dispatched to the consumer
500—A System overview
501—A Registration module
502—A Code generation module
503—A Storage module
504—A Transaction processing module
505—A Payment tracking module
506—A Controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the term consumer device refers to an electronic device that is capable of scanning the Quick Response (QR) codes of one or more products or capable of searching a product from a client application (such as a WizPay application) and initiating a transaction for purchasing one or more products based on the scanned QR codes. For example, the consumer device can be a mobile device, a smart phone, a laptop, a tablet, a personal computer, or the like. The QR code generated for the product and stored in the repository of a registered retailer database is used to uniquely identify the product of the registered retailer.

In an embodiment, the online shopping platform 102 and the application installed on the consumer device can be implemented based on a client-server technology, wherein the online shopping platform 102 is executed on the server-site and the application is executed on the client-site. The application that is executed on the client-site is also referred to as the client application, and the consumer must register with the application for scanning the QR code to initiate a transaction for purchasing the product through the online shopping platform 102.

In an embodiment, the online shopping platform 102 web interface executed on the server-site allows the retailer to register the products and generates the QR code for the registered products, which is stored in the product repository of the registered retailer. Further, the client application, such as WizPay application, executed on the consumer device allows the consumer to scan the QR code or search for the product to initiate a product purchasing transaction through the consumer's device.

The proposed invention refers to capturing the QR code and advertising the QR code on various multi-media sites and allowing the consumer to scan the advertised QR code for purchasing the product online within the network 101. In an embodiment, the QR code can be replaced with any other product identifiers that can be captured and advertised on various multi-media sites that allow the consumer to purchase the product online within the network 101.

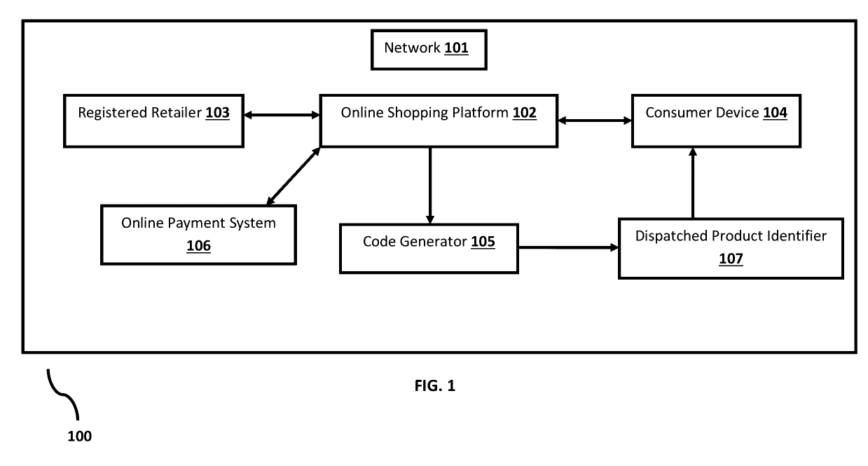

Referring to FIG. 1 illustrates a working overview of the system 100 used to implement the method for enhancing an online shopping experience initiated through an online shopping mobile platform 102 by capturing Quick Response (QR) code for one or more products. As depicted in the figure, an online shopping platform 102 web interface is configured to receive one or more retailer's information for registering the retailer's product within a network 100. Upon registering with the online shopping platform 102, the retailers can generate and store the Quick Response (QR) codes for one or more products associated with the registered retailer 103. Based on the membership plan opted by the retailer(s), the number of QR codes that can be generated and stored for the products are determined Currently, the membership plan can be opted at free of cost by the retailer(s) for the first 200 days post registration with the online shopping mobile platform 102, and an unlimited number of QR codes can be generated for the products during this period. In an embodiment, the online shopping platform 102 generates one or more QR codes for the products using a Code Generator 105 and adds the product with the QR code in the retailer's inventory. Further, the registered retailer 103 can download or print the QR code and dispatch 107 the QR code for advertising the product on one or more marketing media. For example, the QR code generated for a product can be dispatched on newspaper, web portal, product package, flyers, advertisement-boards, or the like. In an embodiment, the consumer device 104 must download and register the application for initiating a transaction by scanning the QR code of the product that is advertised on one or more marketing media. In another embodiment, the consumer can search for the product available in the retailer's inventory database through the search option provided in the client application/a mobile interface/an iOS application. In an embodiment, the online shopping platform 102 is configured to receive one or more transactions initiated on the consumer device 104 and to check the inventory status of one or more products in the registered retailer's database. Further, as the consumer proceeds with the purchasing activity of the selected products, the online shopping platform 102 is configured to interoperate with the online payment system 106 to perform payment related activities. In an embodiment, the online shopping platform 102 is configured to provide a secured payment transaction for the consumer by releasing the payment amount to the registered retailer's account after a stipulated period of time from the delivery date of the product. For example, the online shopping platform 102 can be configured to interoperate with the PayPal online payment system for handling payment related aspects for the purchased products, and further can be configured to transfer the payment amount to the registered retailer's account after 15 days on delivering the products to the consumer. Further, the online shopping platform 102 is configured to process the transaction initiated on the consumer device, maintain the transaction history, and track the initiated transaction to closure. In an embodiment, the consumer device 104 application or the client application is configured to receive the transaction details and the product inventory details from the online shopping platform 102 at frequent intervals.

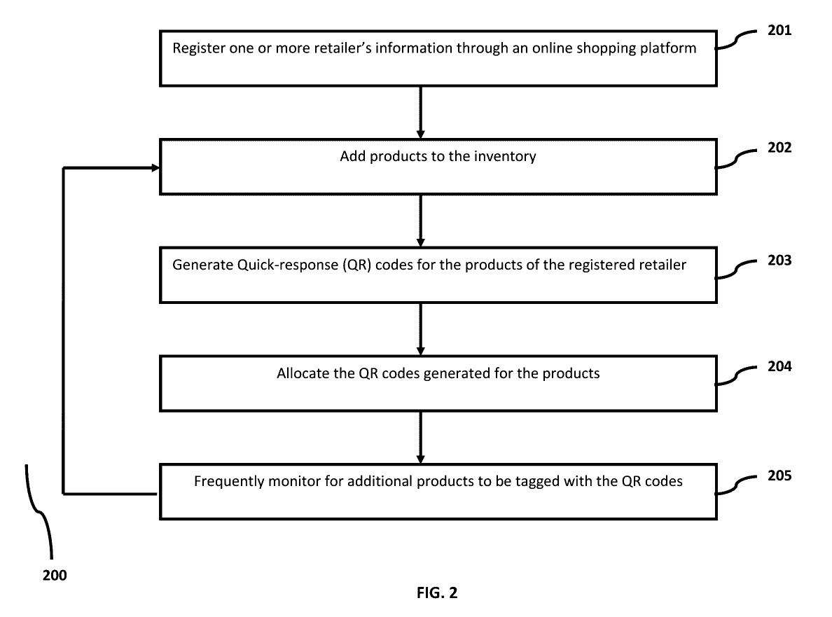

Referring to FIG. 2 illustrates a flow-chart 200 that explains the process of generating the QR code and maintaining the product list in the registered retailer's inventory. Initially, at step 201, the method allows one or more retailers to register their personal and business related details through an online shopping platform 102 web interface. At step 202, the method adds the product list in the inventory database of the registered retailer. At step 203, the method allows the retailers to generate QR codes for one or more products associated with the retailers. At step 204, the method allocates the QR codes of the products associated with the registered retailers. At step 205, the method monitors for additional products that are to be allotted in the registered retailer's product database along with the QR codes.

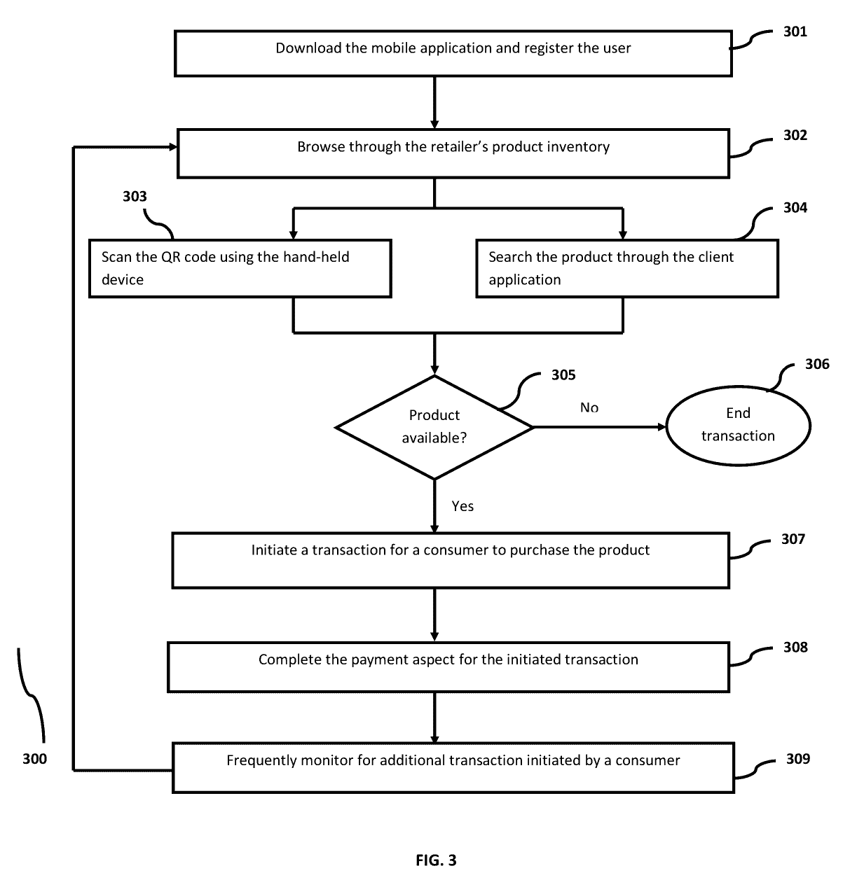

Referring to FIG. 3 illustrates a flow-chart 300 that explains the process of initiating a transaction through the consumer's device. Initially, at step 301, the method allows the consumer to download the client application on the consumer's device 104 and register with the client application. After successfully installing and registering with the client application on the consumer's device 104, at step 302, the client application allows the consumer to browse through the product inventory list based on the consumer's interest in purchasing the product. In an embodiment, the client application allows the consumer to scan the QR code of the product from the consumer's device or provides a search option for the consumer to retrieve relevant information about the product from the inventory database maintained in the online shopping platform 102. At step 303, the client application scans the QR code advertised for the selected product and sends the scanned QR code to the online shopping platform 102 to check for the availability of the product in the product inventory of the registered retailer. Optionally, at step 304, the client application allows the consumer to enter the product details to search for the product in the product inventory of the registered retailer. If the online shopping platform 102 determines that the selected product is not available in the product inventory, then at step 306, the client application notifies the consumer about the non-availability of the product in inventory database. However, if the online shopping platform 102 determines that the selected product is available in the product inventory, then at step 307, the client application on the consumer device 104 allows the consumer to initiate a transaction to purchase the product. At step 308, as the consumer purchases the product, the client application sends the payment related details to the online shopping platform 102 for further processing of the initiated transaction. In an embodiment, the client application can be configured to interoperate with various online payment systems, such as paypal.com, to handle the payment transaction in a secure environment. In an embodiment, the term secure environment refers to handling the transaction payment by implementing a security measure in the online shopping platform 102, wherein the online shopping platform 102 is configured to release the payment amount to the registered retailer's account after a stipulated period of time from the date of delivering the product to the consumer. Further, the online shopping platform 102 completes the transaction upon receiving the payment from the consumer. At step 309, the client application frequently monitors for receiving additional transactions from the consumer.

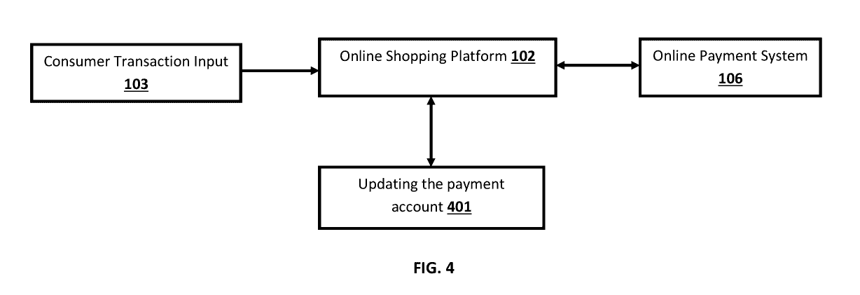

Referring to FIG. 4 illustrates an overview of handling payment account associated with an initiated transaction. As the consumer initiates a transaction on the consumer device 104 for purchasing the product by scanning the QR code advertised on the multimedia, the online shopping platform 101 is configured to receive the initiated transaction from the consumer device 104 for further processing. In an embodiment, the online shopping platform 101 is configured to interoperate with an online payment system 106 for handling the payment account through a secured environment. For example, the consumer can make his/her payments through a paypal.com account after purchasing the product. Further, the online shopping platform 101 is configured to receive the payment through the online payment system 106 in various modes and the platform 101 is configured to process and update the payment account 401 maintained for the initiated transaction. Further, as a security measure for the consumer involved in purchasing the products, the online shopping platform 102 is configured to release the payment amount to the registered retailer's account after a stipulated period of time from the date of delivery of the products to the consumer.

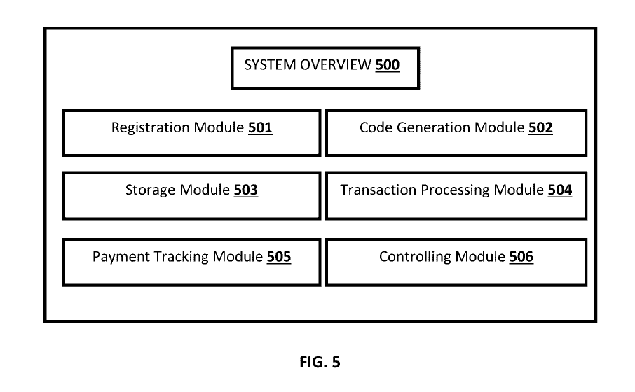

Referring to FIG. 5 illustrates a system overview 500 of components used to implement the method for enhancing an online shopping experience by capturing the QR code of one or more products through an online shopping platform 102, wherein the system comprises of the following components: a Registration module 501, a Code generation module 502, a Storage module 503, a Transaction processing module 504, a Payment tracking module 505, and a Controlling module 506. In an embodiment, the Registration module 501 is configured to register one or more retailers with the online shopping platform 102 to market the products online. In an embodiment, the Code generation module 502 is configured to generate the QR code for the products associated with the registered retailers. In an embodiment, the Storage module 503 is configured to store the inventory of product database for one or more registered retailers and the transaction history associated with the registered retailers. In an embodiment, the Transaction processing module 504 is configured to process the transaction initiated by the consumer, monitor the initiated transaction, and track the initiated transaction to closure. In an embodiment, the Payment tracking module 505 is configured to handle payment related aspects associated with an initiated transaction. In an embodiment, the Controlling module 506 is configured to transfer data or information across various modules supported in the system 500.

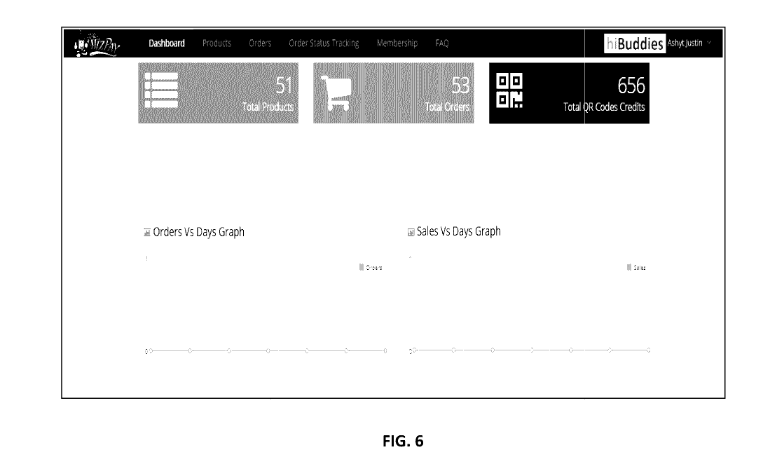

Referring to FIG. 6 illustrates a screen-shot of the online shopping platform main page. As depicted in the figure, the online shopping platform 102 main page displays a dashboard that provides an information overview about the products marketed by the registered retailers and details about the transactions handled by the online shopping platform 102.

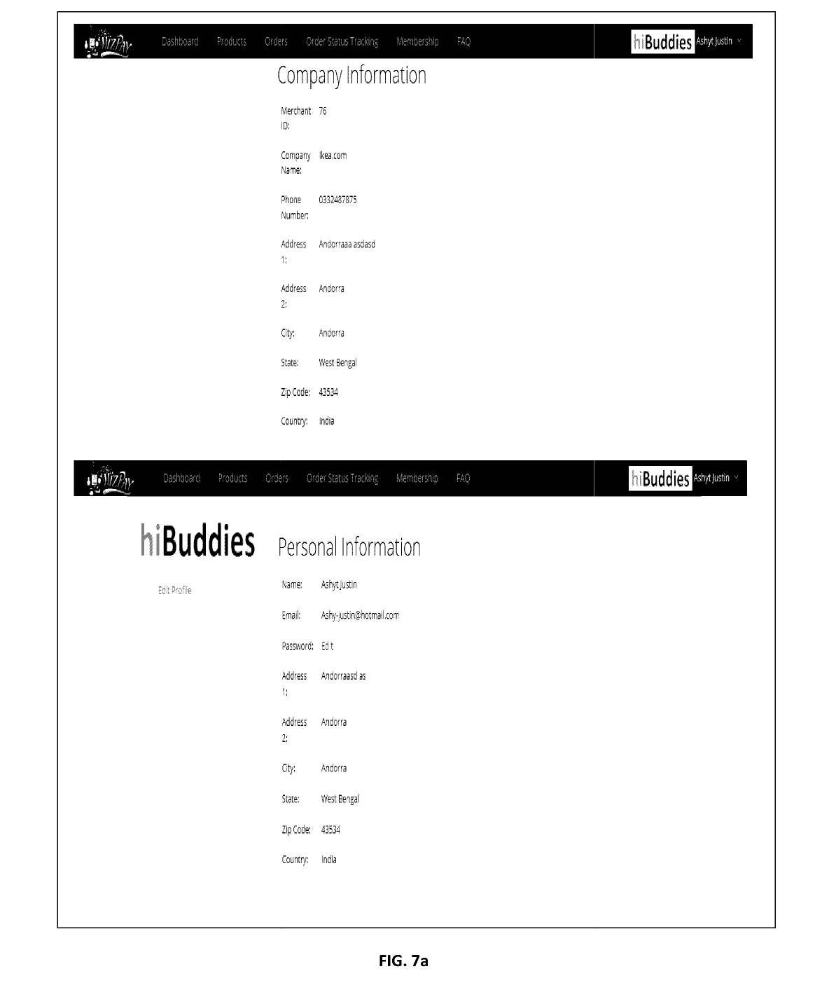

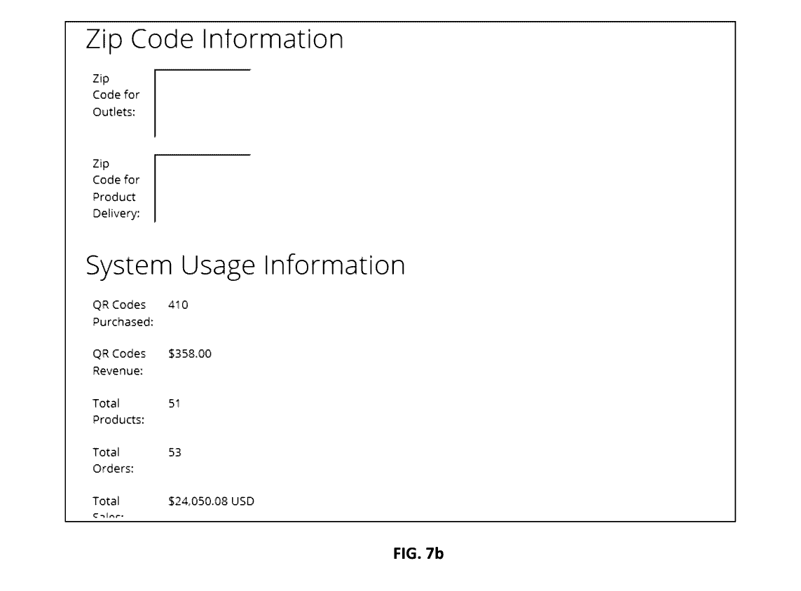

Referring to FIGS. 7a and 7b illustrate screen-shots of the online shopping platform 102 used to capture information related to a retailer and associated products. As depicted in FIGS. 7a and 7b, the online shopping platform 102 web interface allows the retailer to enter his/her personal and business detail for registering the retailer and displays the transaction related information associated with the registered retailer.

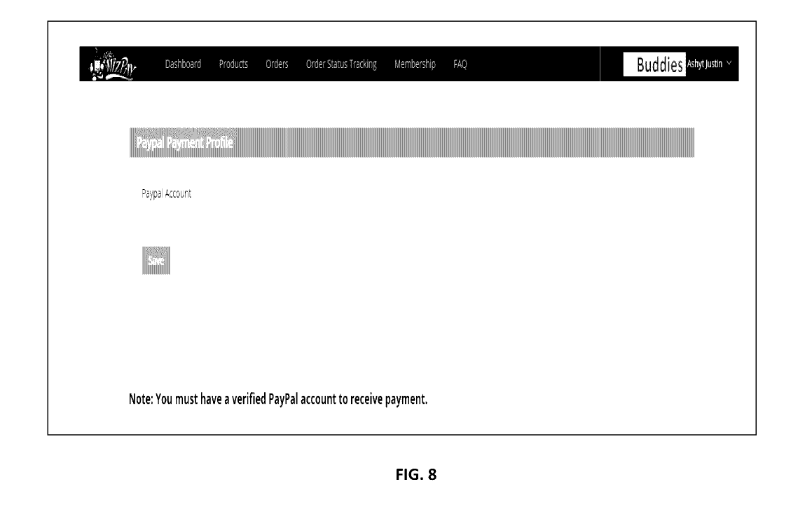

Referring to FIG. 8 illustrate screen-shot of the online shopping platform 102 web interface for creating a payment account. As depicted in the figure, the online shopping platform 102 allows the registered retailer to create a payment account through an online payment system 106, such as paypal.com. Based on the balance amount available in the payment account, the registered retailer can add list of products to the repository with the QR code associated for each these products.

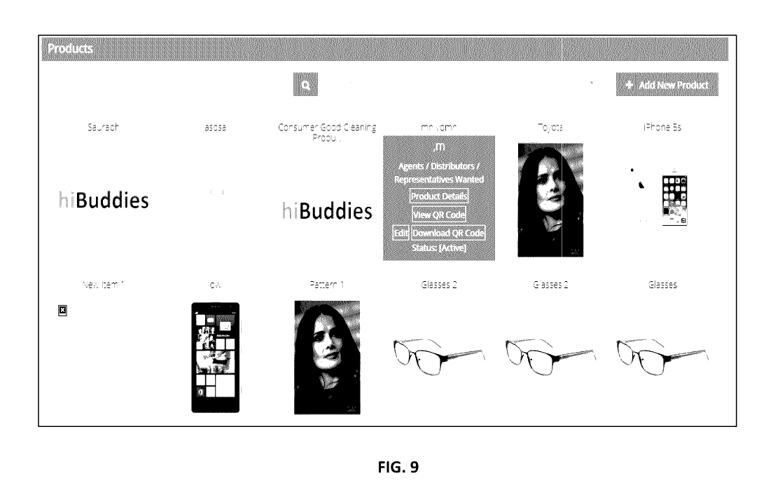

Referring to FIG. 9 illustrates screen-shot of products available in the online shopping platform 102 repository. As depicted in the figure, the online shopping platform 102 web interface allows the consumers to view the list of products stored in the repository of the registered retailers along with the QR code generated for the products. Consumers can purchase the products by referring to the information displayed on the client application. In an embodiment, the product repository stored on the online shopping platform 102 is synchronized on the consumer's device 104 at regular intervals based on which the consumer can initiate a transaction.

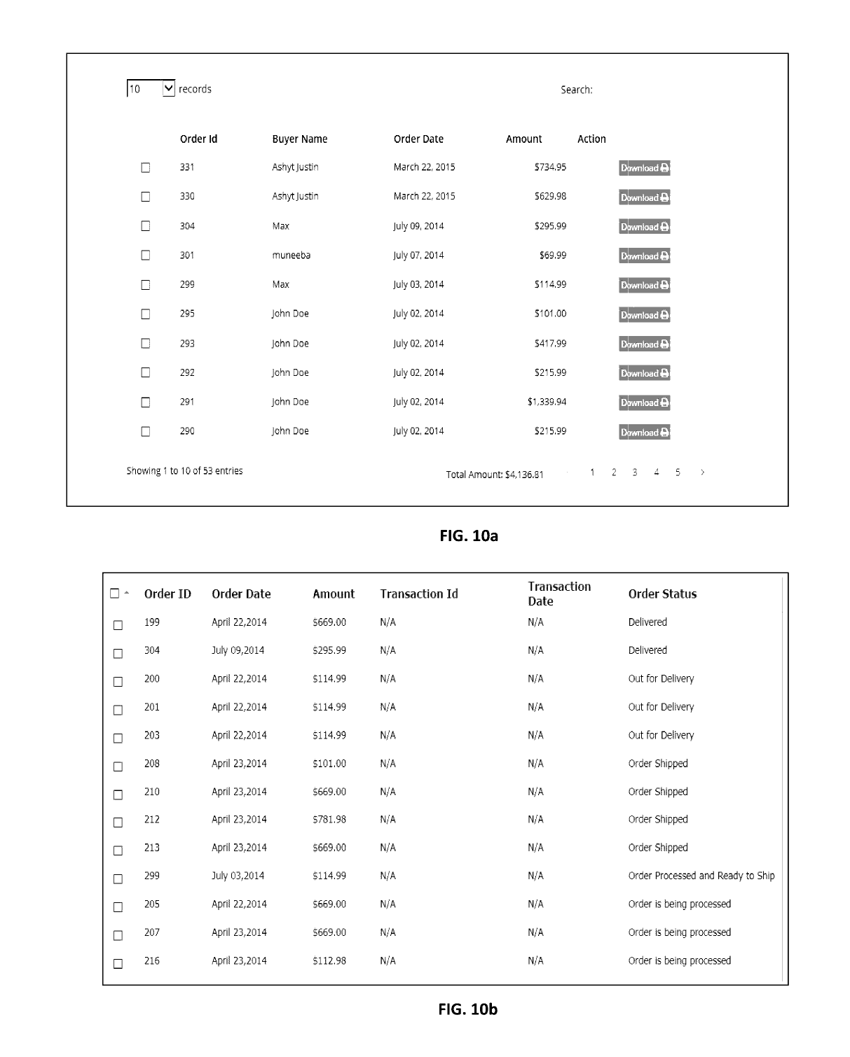

Referring to FIGS. 10a and 10b illustrates screen-shots of product ordering status maintained by the online shopping platform 102. As depicted in the figure, the online shopping platform 102 maintains the transaction status initiated by the consumer for purchasing the product associated with the registered retailer. The transaction status provides information about transactions handled for one or more consumers along with the payment details tracked until the completion of the transaction.

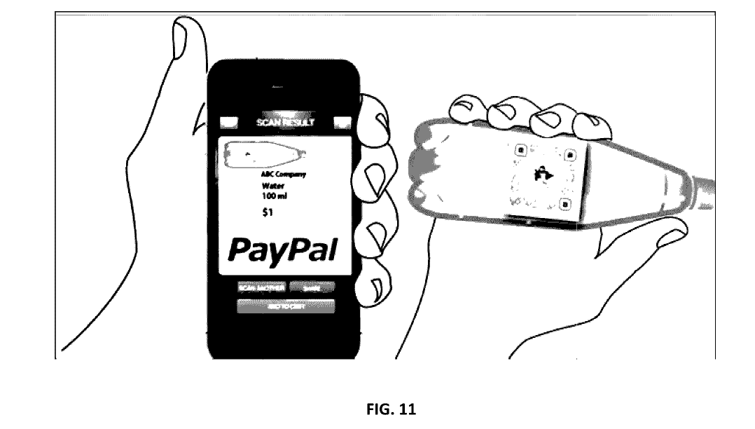

Referring to FIG. 11 illustrates a client application scanning the QR code of the product on the consumer device 104. As depicted in the figure, the client application initialized on the consumer device 104 scans the QR code of the product and displays information based on the scanned QR code. In an embodiment, the client application scans the QR code of the product from the consumer device 104 and retrieves relevant information from the product repository maintained in the online shopping platform 102.

1. A method for enhancing an online shopping experience by capturing at least one product identifier through an online shopping platform, wherein said method comprises of:
registering at least one retailer's information through said online shopping platform web interface;
generating a Quick-Response (QR) code for at least one product marketed by said at least one registered retailer;
dispatching the generated QR code of said at least one product for marketing said at least one product on at least one marketing media;
allocating said QR code that is generated for said at least one registered retailer;
receiving at least one transaction initiated by a consumer to buy said at least one product from said online shopping platform;
checking the availability of said at least one product in said online shopping platform to complete said at least one transaction initiated by said consumer; and
handling the payment aspect for an initiated said at least one transaction by adopting a security measure for said consumer payment.

2. The method as claimed in claim 1, wherein generating the QR code for said at least one product comprises of hovering said at least one product for generating the QR code of said at least one product that can be stored in said online shopping platform for future reference.

3. The method as claimed in claim 1, wherein dispatching the generated QR code on said at least one marketing media comprises of advertising the generated QR code in newspapers, web portals, product package, flyers, advertisement-boards, or the like.

4. The method as claimed in claim 1, wherein the method allows said consumer to initiate said at least one transaction either by scanning the QR code that is generated and dispatched with said at least one product or by performing a product search using a client application.

5. The method as claimed in claim 1, wherein handling the payment aspect for said at least one transaction initiated by said consumer comprises of:
setting up a payment account for said at least one registered retailer; and
maintaining the amount in said payment account based on the payment details tracked for said at least one transaction initiated by said consumer.

6. The method as claimed in claim 5, wherein the payment details can be tracked by integrating the existing online payment system such as PayPal, E payment, digital wallet, card payment or the like with the online shopping platform.

7. The method as claimed in claim 1, wherein said method synchronizes the information such as the QR code of said at least one product, availability of said at least one product maintained in a repository of said online shopping platform with said consumer's device at regular intervals.

8. The method as claimed in claim 5, wherein said method adopts a security measure while handling payment made by said consumer by releasing the payment amount from said online shopping platform to said payment account set up for said at least one registered retailer within a stipulated period of time after delivery of said at least one product.

9. A system for enhancing an online shopping experience initiated through an online shopping platform by capturing at least one product identifier, wherein said system comprises of a server, a client application and said system is configured to:
allow at least one retailer to register through said online shopping platform web interface;
generate a Quick-Response (QR) code for at least one product marketed by said at least one registered retailer;
dispatch the generated QR code of said at least one product for marketing purpose on at least one marketing media;
allocate said QR code that is generated for said at least one registered retailer;
receive at least one transaction initiated by a consumer to buy at least one product from said online shopping platform;
check for availability of said at least one product in said online shopping platform to complete said at least one transaction initiated by said consumer; and
handle the payment aspect for an initiated said at least one transaction by adopting a security measure for said consumer payment.

10. The system as claimed in claim 9, wherein generating the QR code for said at least one product comprises of hovering said at least one product and printing the QR code for said at least one product that can be stored in said online shopping platform for future reference.

11. The system as claimed in claim 9, wherein dispatching the generated QR code on said at least one marketing media comprises of advertising the generated QR code in newspapers, web portals, product package, flyers, advertisement-boards, or the like.

12. The system as claimed in claim 9, wherein the system is configured to allow said consumer to initiate said at least one transaction either by scanning the QR code that is generated and dispatched with said at least one product or by performing a product search using a client application.

13. The system as claimed in claim 9, wherein handling the payment aspect for said at least one transaction initiated by said consumer comprises of:
setting up a payment account for said at least one registered retailer; and
maintaining the amount in said payment account based on the payment details tracked for said at least one transaction initiated by said consumer.

14. The system as claimed in claim 13, wherein the payment details can be tracked by integrating the existing online payment system such as PayPal, E payment, digital wallet, card payment or the like with the online shopping platform.

15. The system as claimed in claim 9, wherein said system is configured to synchronize the information such as the QR code of said at least one product, availability of said at least one product maintained in a repository of said online shopping platform with said consumer's device at regular intervals.

16. The system as claimed in claim 13, wherein said system is configured to adopt a security measure while handling payment made by said consumer by releasing the payment amount from said online shopping platform to said payment account set up for said at least one registered retailer within a stipulated period of time after delivery of said at least one product.
